(19) United States
(12) Patent Application Publication
(10) Pub. No.: US 2005/0041693 A1
(43) Pub. Date: Feb. 24, 2005

(54) Method and apparatus for frequency synchronization in MIMO-OFDM wireless communication systems

(76) Inventor: Paolo Priotti, Yokohama-Shi (JP)

Correspondence Address: Stephen J. Wyse;Scheef & Stone, L.L.P., Suite 1400, 5956 Sherry Lane, Dallas, TX, 75225, US

(21) Appl. No.: 10/646,524

(22) Filed: Aug. 22, 2003

(51) Int. Cl. H04J 3/06; H04J 11/00

(52) U.S. Cl. 370/503; 370/203

(57) ABSTRACT

A method and apparatus for synchronizing in the receiver of an orthogonal frequency division multiplexing (OFDM) wireless communication system, and in particular a multiple input multiple output (MIMO) OFDM system. The OFDM transmitter inserts training symbols into the transmission signals, and when the transmission is received a frequency synchronization module develops from them a weighted representation of the received signal from which frequency offset estimates for use in frequency offset compensation may be made.

### FIELD OF THE INVENTION

The present invention relates generally to the field of mobile telephony, and more particularly to a method and apparatus for frequency synchronization of MIMO-OFDM systems using frequency-selective weighting.

### BACKGROUND OF THE INVENTION

The demand for wireless communication systems has increased dramatically in recent years. Although radio transmission has been in use for some time, both for broadcasting and for two-way voice communications, this use has generally been confined to specific, well-known applications. The advent of cellular telephone systems, however, has not only made radio communication available to a large majority of the population, it has also given rise to technological advances that have reduced the cost of owning and operating a portable radio that may be used as a standard telephone.

A cellular telephone system, generally speaking, involves a switched network of interconnected nodes arranged in a somewhat hierarchical fashion to route calls from one base station to another, or between a cellular network base station and some other network through a gateway switching device. Network subscribers use portable radio devices called mobile telephones or cell phones to communicate with one or nearby base stations over an air interface radio channel. The interconnected network infrastructure nodes, and in particular the base stations, are spread out over the network coverage area such that a subscriber in the area is always near enough to one for effective wireless communication. Each base station is associated with one or more antennas, each antenna handling communications with mobile stations in a relatively-small geographic area called a “cell”.

The wireless nature of the air interface means the subscriber's access to telephone service is not restricted to their home or business. It also means that they may relocate even during an on-going telephone call. The network is designed so that a relocating subscriber, or more accurately their mobile telephone, may be switched from communicating with one base station antenna to another, often with little or no perceptible interruption in service. From the perspective of network resources, the cellular nature of the network also means that its limited number of channels may be re-used over and over throughout the network because the relatively low-powered mobile stations will not interfere with the signals of others operating in non-adjacent cells.

Advances in computing technology, analogous to those in cellular networks, have also enabled the widespread ownership of small but powerful computers, often called personal computers. In contrast to the huge centrally-located computer, personal computers are small enough to fit on a desktop (or even smaller) and have sufficient computing power to permit the use of a large number and variety of applications such as word-processing, spreadsheets and accounting programs, graphic-presentation generation, and computer gaming.

Personal computers do not always operate in isolation, however, but are very often connected with other computers of various kinds for the purpose of sharing data, computing capability, and peripheral devices such as printers. They may also be interconnected simply for communication with one another. Such network may be large or small, and various schemes have been devised to allow them to communicate with each other and share resources efficiently. Connections by any computer to the network may be continuous or ad hoc, that is, established when necessary and then released.

A small network, that is one connecting computers located relatively close together, may be referred to as a local area network (LAN). LANs are used, for example, to connect the computers used by the employees of a business to a central server (and thereby to each other). The server may be used to store data, house certain widely-used applications, and to handle communications both inside and to nodes outside of the network. Any given computing device may also be equipped with and transmitter and receiver to access a wireless channel for communicating with the network though a similarly-equipped access point. A LAN permitting this form of access may be referred to as wireless LAN (WLAN).

Larger networks exist, of course, the most prominent example being the Internet. The Internet is actually a network of many computer networks that communicate with each other using commonly-accepted protocols. Many of these networks reside at universities, businesses, and governmental units that permit selective access to the large amounts of information stored on there. Connecting to the Internet therefore allows access to an incredibly large amount of data and other resources. Internet access has become for this reason very popular, especially with the development of an application referred to as the World Wide Web (WWW), which allows users with only a minimal amount of training to use programs called Web browsers to retrieve text, graphics, and other types of information residing in documents called Web pages.

Regardless of the application, however, any network transmitting information over a wireless channel employs a certain basic structure such as the one illustrated in FIG. 1. FIG. 1 is a simplified block diagram illustrating selected components of a wireless transmission system 100. Wireless transmission system 100 includes a transmit side 105 and a receive side 155. This illustration implies that the two sides are located in different terminals that are attempting to communicate with each other, although note that typically a terminal will include both transmit and receive functions.

The information to be transmitted, which may be voice or data information, is first provided to an encoder 110 to be encoded into digital form. Note that the terms ‘data’ and ‘information’, however, may be used interchangeably herein. No formal distinction is thereby intended unless it is specifically stated or apparent from the context. The encoded information is then modulated onto a carrier wave in a modulator 120 and provided to transmitter 130, where it is amplified for transmission via radio channel 150 through antenna 140.

The receiver 170 receives the transmitted radio frequency (RF) signal through antenna 160. Receiver 170 provides the received signal to a demodulator 180, which recovers (as well as it is able) the encoded sequence. This is provided to a decoder 190 for replication of the originally transmitted information. As should be apparent, the goal of any such communication system is the faithful reproduction of this information.

The air interface, however, introduces several challenges to reaching this goal. For one thing, the limited available transmission bandwidth much be utilized in such a way that signals sent by one user do not interfere significantly with those sent by another. The cellular telephone network, described above, is one way to address this concern. More basically, however, and given application is assigned a limited range of the available frequencies in the electromagnetic spectrum. Each network, then, must devise ways to allow as many subscribers as possible to use the assigned bandwidth. Several techniques have been developed. For example, in frequency division multiple access (FDMA), the available bandwidth is divided into channels defined by a more narrow frequency range. There is practical minimum size to such channels, however, creating a limit on the number of channels that can be created.

In time division multiple access (TDMA) each frequency channel is divided into a number of time slots, the actual transmission channel being formed by a combination of a time slot and a frequency. This permits the transmission of much more data by using each frequency channel more efficiently. Code division multiple access (CDMA), on the other hand, uses a number of spreading codes to spread the signal to be transmitted across the entire available bandwidth (or a selected portion thereof). The spreading codes are unique and assigned to each user, normally on an ad hoc basis. Multiple transmissions may thereby be sent simultaneously as each user, using the assigned spreading code, detects only that signal in the transmission that it was intended to receive.

Another method of increasing the capacity of wireless communication systems is through a technique called orthogonal frequency division multiplexing (OFDM). In OFDM, data symbols are mapped into a relatively large number of sub-carriers, or frequency bins for transmission by taking an inverse fast Fourier transform (IFFT) to create a time domain signal. Each frequency bin is orthogonal with respect to the others so that they do not (at least in the ideal case) interfere with each other. At the receiver the time domain signal is converted back to a frequency domain signal using a fast Fourier transform (FFT) so that the originally transmitted information signals can be detected. OFDM makes more efficient use of the available spectrum than other most other methods, and therefore may transmit more data using a given transmission bandwith.

Another challenge presented by use of the air interface is that it is not as reliable a communication channel as, for example a wire or cable. It can be affected, for example, by weather and other environmental conditions. One particularly prevalent problem involves the multipath effect. Transmitted radio signals, generally speaking, spread out in propagation, and different potions of the signal may reflect off or be otherwise impeded by the various objects each portion encounters. The result is that the different portions of same signal take different paths to the receiver and therefore arrive at slightly different times. These different portions may then interfere with each other and cause fading.

One manner of addressing this challenge is through the use of transmission diversity. Time diversity involves introducing time redundancy into the transmitted data and, where the fading is time variant, allows the receiver to more accurately recover the transmitted information. Spatial diversity may also be used. In spatial diversity more than one transmission antenna is used, the antennas being spaced apart at a distance selected to provide a desired level of correlation between the data transmitted by each of the antennas.

If more than one antenna is used at the receiver as well, the communication system is referred to as a multiple input multiple output (MIMO) system. In MIMO systems, the number of receive side antennas is typically at least as great as the number of antennas on the transmit side. Each transmit and receive antenna combination defines a separate channel that exhibits different fading conditions. This difference can be exploited to combat the effects of multipath fading over the air interface.

OFDM is also effective in reducing multipath effects, and its use in connection with MIMO antenna diversity creates a high-capacity system that is less susceptible to fading. There remain obstacles to overcome, however. For example digital modulation techniques may require precise tuning of the transmitter and receiver for correct decoding of the transmitted information. Multicarrier modulations can be more sensitive than single-carrier techniques to frequency offsets, and among them OFDM is highly sensitive to offsets corresponding to a fraction of the spacing between subcarriers. This is significant because frequency offset between the transmitter and the receiver can cause loss of orthogonality between subcarriers in OFDM and introduce undesirable performance degradation.

Frequency offsets are due to several different causes. Usually large frequency offsets are due to inaccuracy of the local oscillators in the transmitter and receivers. Smaller frequency offsets can be caused by Doppler shift in the case of moving transmitter or receiver, and instantaneous phase noise can be caused by additive noise. Usually in OFDM receivers it is necessary to include one or more stages of frequency synchronization that reduce the original frequency offset to a small fraction of the intercarrier spacing. The residual frequency error is then usually compensated in the receiver by a phase-tracking section.

Needed therefore is an MIMO OFDM radio system employing a method capable of more accurately synchronizing a transmitted signal. The present invention provides just such a solution.

### SUMMARY OF THE INVENTION

In one aspect, the present invention is a method for the synchronization of multiple-input multiple output (MIMO) orthogonal frequency division multiplexing (OFDM) systems including the steps of receiving a OFDM transmission, developing a weighted representation of the received signal, and performing frequency synchronization of the received signal using the developed weights.

In another aspect, the present invention is an apparatus for synchronizing received signals in a MIMO OFDM system, including a plurality of antennas for receiving the OFDM transmission signal, a frequency synchronization module couple to each of the antennas for developing a weighted representation of the received signal, and a frequency offset compensation module for performing frequency offset compensation on the received signal using the weighted representation developed by the frequency synchronization module.

This invention is directed to developing the weighting in the frequency domain to improve the performance of frequency offset estimation even when CSI (channel state information) is not available. This, in combination with the efficient use of spatial diversity, lets the proposed algorithm achieve superior performance even in fast fading channels and low SNR condition. The algorithm weights the received training symbols from each antenna with their SNR before estimating the frequency offset, such achieving a higher quality estimate compared to prior art algorithms. The separation and weighting of the training symbols is possible because training symbols do not overlap (or not fully) in the frequency domain. Two possible sets of training symbols may be developed, including a more complex set and a less complex set.

### BRIEF DESCRIPTION OF THE DRAWINGS

For a more complete understanding of the present invention, and the advantages thereof, reference is made to the following drawings in the detailed description below:

FIG. 1 is a simplified block diagram illustrating selected components of a wireless transmission system.

FIG. 2 is a simplified block diagram illustrating selected components of a MIMO OFDM communication system such as one that might advantageously employ the synchronization algorithms of the present invention.

FIG. 3 illustrates in block diagram form a method 300 of synchronization in an MIMO OFDM wireless communication system according to an embodiment of the present invention.

FIG. 4 presents a series of frequency-domain plots illustrating the use of weighting in the frequency domain.

### DETAILED DESCRIPTION

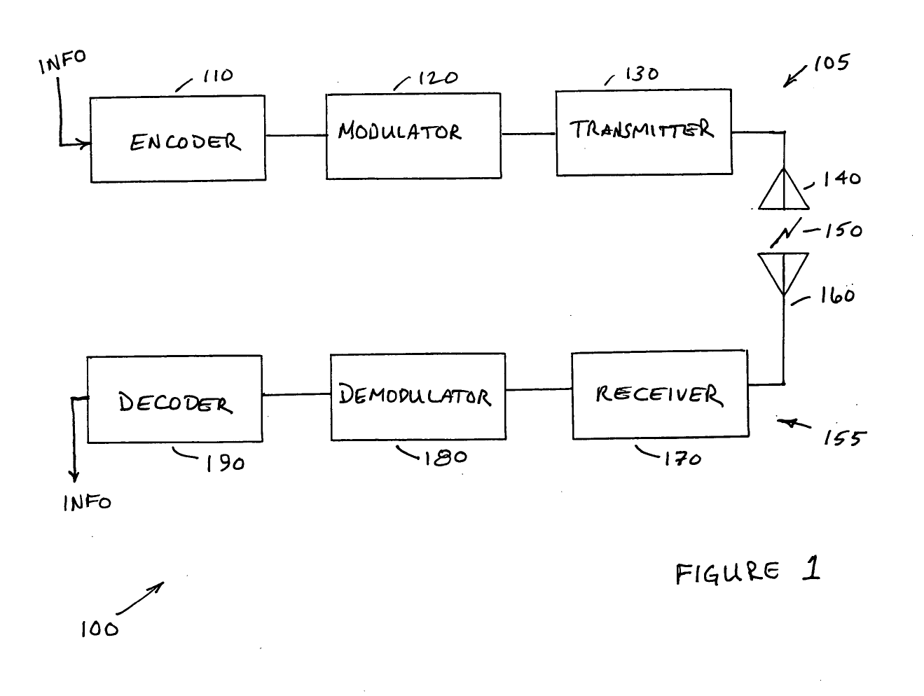

FIGS. 1-4, discussed herein, and the various embodiments used to describe the present invention are by way of illustration only, and should not be construed to limit the scope of the invention. Those skilled in the art will understand the principles of the present invention may be implemented in any similar radio-communication device, in addition to those specifically discussed herein.

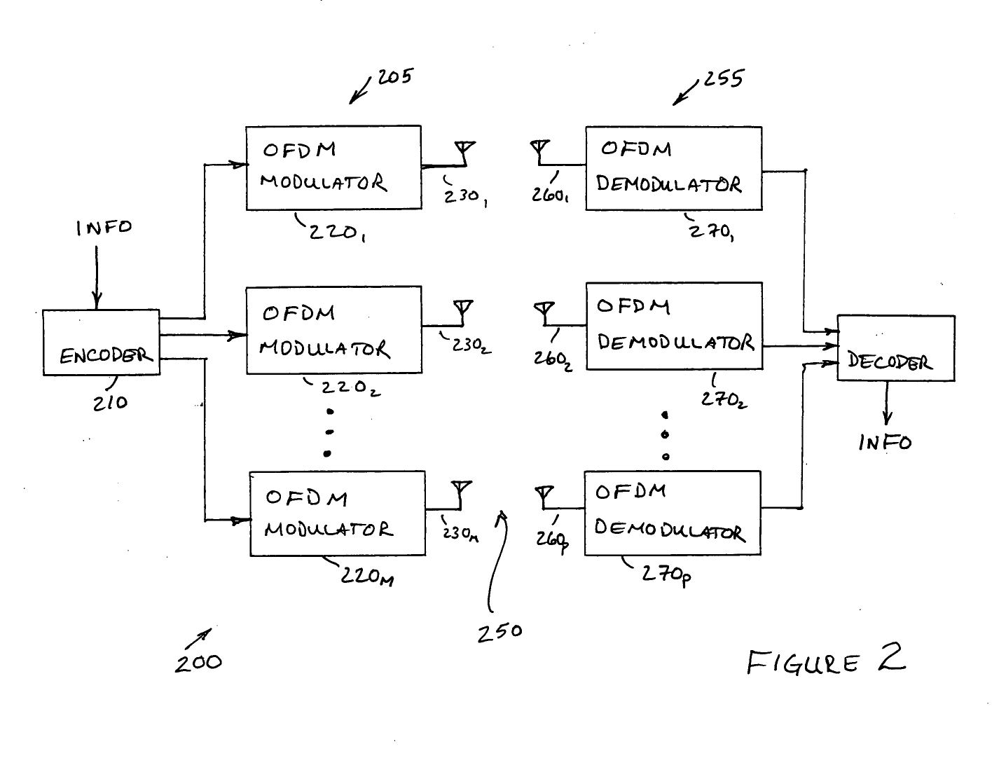

The present invention is directed to method and apparatus for synchronizing a received signal that has been transmitted in a MIMO (multiple-input multiple output) OFDM (orthogonal frequency division multiplexing) communication system. FIG. 2 is a simplified block diagram illustrating selected components of a MIMO OFDM communication system 200 such as one that might advantageously employ the synchronization algorithms of the present invention. System 200 has a transmit side 205 and a receive side 255, which represent the corresponding components of separate terminal that are communicating with each other over the air interface 250.

Note, however, that the method an apparatus of the present invention may also be applied to a single input single output (SISO) wireless transmission system, which can be considered a special case of MIMO system where the number of antennas at the transmitter and at the receiver is one.

As with conventional wireless systems, information to be transmitted is provided to an encoder 210 for encoding. After encoding, however, the data stream is separated into multiple paths, and each data path is provided to an OFDM modulator 220_{1 . . . M} that applies an inverse fast Fourier transform (IFFT) (or an inverse discrete Fourier transform (IDFT)) to convert the data stream to a time domain signal. The signal is then transmitted using an antenna 230_{1 . . . M} associated with a respective one of the OFDM modulators. (Although only three such combinations are illustrated, there could be more or less.)

After propagating though a radio channel defined on the air interface 250, each of the transmitted signals (that is, one from each of the M transmit antennas) arrive at the receive antennas 260_{1 . . . P} and is from their passed to a corresponding OFDM demodulator 270_{1 . . . P}, which applies a fast Fourier transform (FFT) (or IDFT) in order to convert the signal back to the frequency domain. In the illustrated embodiment, the outputs of the OFDM demodulators are then combined and provided to a decoder 280 for recovery of the transmitted information.

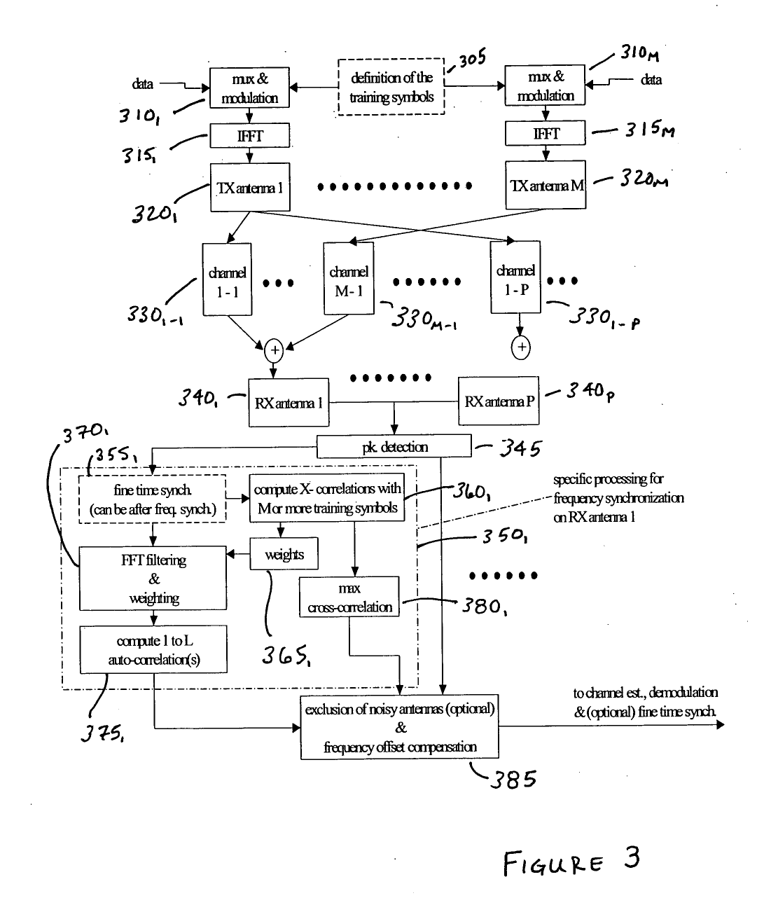

FIG. 3 illustrates in block diagram form a method 300 of synchronization in an MIMO OFDM wireless communication system, such as the one illustrated in FIG. 2, according to an embodiment of the present invention. Note that many of the redundant blocks (corresponding, for example, with multiple antennas or modulators) have been omitted for clarity. At the start of the process, training symbols are assumed to be defined at block 305. Training symbols are sequences know to and used to calibrate the receiver in various ways, so that it can more accurately recover the (unknown) information being transmitted. In FIG. 3, encoded data is shown being provided to a multiplexing and modulation function 310₁ . . . 310_{M} (shown for convenience as a single function), and then an IFFT 315₁ . . . IFFT 315_{M} is applied. The output of each IFFT function is supplied to a corresponding transmitter antenna 320₁ . . . 320_{M}.

From each transmitter the signal is propagated to the receiver, where it is received at each receiver antenna 340₁ . . . 340_{P}. As mentioned above, each transmitter antenna-receiver antenna pair defines a channel, which channels are illustrated in FIG. 3 by channel 330₁₋₁, representing the channel defined by transmit antenna 3201 and receiver antenna 3401, channel 330_{M-1} (from 320_{M} to 340₁), and channel 330_{1-P}. (From the illustrated channels, the nature of those that have been omitted should be apparent.)

The signal received at the receiver is then, in the illustrated embodiment, applied to a packet detection function 345. The MIMO OFDM wireless system will often be used for the transmission of data in packet form, and the receiver must find in the received signal the start of each packet (or in some cases frame) so that the data can be properly interpreted. This process may be considered a course-time synchronization step. From packet detection function 345, the signal received from antenna 340₁ is provided to a frequency synchronization module 350₁.

In the illustrated embodiment, fine-time synchronization may optionally be performed at this stage. If so, the signal from packet detection function 345 is provided to a fine-time synchronization module 355₁. (In another embodiment, this function may be performed after frequency synchronization has been completed.) Correlations with M or more training signals is then performed at block 360₁ and weights (block 365₁) and a max correlations (block 380₁) are determined. Preferably, computation of all the possible cross correlations between the received signal and the transmitted training symbols is performed in the time domain. If fine symbols timing has already been aligned, then a single cross correlation for each training symbol is needed. If not, D cross correlations will have to be computed with a sliding sum.

In accordance with this embodiment of the present invention, using the weights calculated at 365₁, FFT filtering and weighting in the frequency domain (block 370₁) is then performed. Note that the received signal is decomposed by FFT in the received training symbols. If the received training symbols do not overlap in the frequency domain, then ther is no interference between symbols during MIMO transmission. After applying multiplicative weights, the signal can be recomposed by application of an IFFT (not shown) and the autocorrelation calculated (block 375₁). It should be noted, however, that it is also possible to operate directly in the frequency domain without applying the IFFT. From the phase of the autocorrelation the frequency offset can be estimated. If the antenna is considered active, then its contribution to the total frequency offset can be taken into account. Using the result of this computation and the max cross-correlation (block 380₁), the frequency offset compensation is then performed on the received data (block 385₁). An offset opposite to the average estimated offset is applied to the signals of all receiver antennas. The signal is then output for channel estimation and demodulation, and eventually decoding (not shown in FIG. 3).

An algorithm for weighting in the frequency domain will now be presented. Note this algorithm is intended to improve the performance of frequency offset estimation even when CSI (channel state information) is not available. The algorithm weights the received training symbols from each antenna with their signal to noise ratio (SNR) before estimating the frequency offset, thereby achieving a higher quality estimate, as compared to previously developed algorithms. The separation and weighting of the training symbols is possible because training symbols do not overlap (or not fully) in the frequency domain.

First, consider an OFDM signal at the m-th transmit (TX) antenna. The set Γ of all subcarriers may be partitioned into K subsets Θₖ, such that [symbol]
Θₖ=Γ, k=1 . . . K, K≧M (1).
If Cₖ is the number of elements in Θₖ, then the training symbols transmitted from the same antenna may be defined in the frequency domain as:
Xₖ(n)=PN^{C}^{ₖ}(l) when nεΘₖ∪n=lξ, and 0 for n elsewhere; l=1 . . . Cₖ (2).
In equation (2) PN^{C}^{ₖ} is a pseudo-noise sequence of length Cₖ. ξ represents the period on the frequency axis with which non-null subcarriers are present in the training symbols. xₖ(t) has a time period of D=N/ξ. In practical implementations PN sequences will have to be chosen so that the resulting PAPR is limited.

Indicating, with Sₖ the spectral representation of xₖ(t), the signal at the p-th receive (RX) antenna can be expressed in the frequency domain as:

$${R}_{p} = {\sum }_{k = 1}^{K} {S}_{k} {H}_{p k} + {W}_{p k} , p = 1 … P , \qquad ( 3 )$$

where Hₚₖ denotes the frequency-variant channel response between the sub-band corresponding to Θₖ in a given TX antenna and the p-th RX antenna, and Wₚₖ is an additive noise contribution.

Next, define

$${Ψ}_{p k} ( l ) = {\sum }_{t = 0}^{N - 1} {r}_{p} ( t ) \cdot {x}_{k}^{*} ( t + l ) , n = 1 … D ,$$

the cross-correlation over one symbol, between the training symbols and time representation of the received signal

$${r}_{p} ( t ) = {\sum }_{n = 0}^{N - 1} {R}_{p} ( n ) {ⅇ}^{j 2 π n t / N} . \qquad ( 4 )$$

Letting

$${κ}_{p k} = {max}_{k ∈ [ 1 … D ]} \vert {Ψ}_{p k} ( l ) \vert ,$$

a weighted representation of the received signal is built up and expressed as:

$$\begin{matrix}{\tilde{r}}_{p} ( t ) = {\sum }_{k = 1}^{K} {\tilde{r}}_{p k} ( t ) , & ( 5 ) \\ where {\tilde{r}}_{p k} ( t ) = {\sum }_{n ∈ {Θ}_{k}} {R}_{p} ( n ) {β}_{p k} {ⅇ}^{j 2 π n t / N} . & ( 6 )\end{matrix}$$

The weight

$${β}_{p k} = \frac{{κ}_{p k}}{{\prod }_{k = 1}^{K} {κ}_{p k}}$$

has the function of enhancing the sets of subcarriers that have higher SNR, where the noise includes both additive noise and propagation distortion.

The final step is to calculate the auto-correlation of the weighted signal:

$${Ψ}_{p}^{D} = {\sum }_{t = 0}^{N - 1} {\tilde{r}}_{p k} ( t ) \cdot {{{r}^{*}}^{\sim}}_{p } ( t + D ) . \qquad ( 7 )$$

If fₛ is the sampling frequency, the estimated frequency offset on the p-th RX antenna is given by:

$${f}_{off , p} = - {f}_{s} \frac{{∠Ψ}_{p}^{ D}}{2 π D} , \qquad ( 8 )$$

for a maximum estimate of ξ/2 intercarrier spacings.

Immunity to noise can also be traded off for estimation range with the use of a more general autocorrelation:

$${Ψ}_{p , tot} = {\sum }_{k = 1}^{L} ( {Ψ}_{p}^{k D} {ⅇ}^{- ( {∠Ψ}_{p}^{k D} ) / k} ) \qquad ( 9 )$$

where the maximum estimate is reduced to ξ/(2L) spacings.

In the hypothesis that all RX antennas are subject to the same frequency offset (that applies in case a unique local oscillator is used), the frequency offset estimation can be averaged:

$${f}_{off} = \frac{1}{P} {\sum }_{p = 1}^{P} {f}_{off , p} . \qquad ( 10 )$$

Moreover, to eliminate strong interference on single antennas when present, the algorithm can optionally be made so that it includes in the final average the contribution from the p-th RX antenna if and only if the following condition is satisfied:

$${max}_{k ∈ [ 1 … K ]} ( {κ}_{p k} ) > ɛ \cdot {max}_{k ∈ [ 1 … K ] , p ∈ [ 1 … P ]} ( {κ}_{p k} ) , \qquad ( 11 )$$

where ε is a threshold: 0<ε<1. Its value can be adjusted for maximization of performance depending on the transmission environment (a reasonable value could be e.g. 0.3).

This first embodiment has been based on the simple assumption K=M. Though the training symbols can be interspersed with different patterns in the frequency domain, a simple choice is the use of a continuous bandwidth (BW) region for a give antenna. It should be apparent that a finer subdivision in the frequency domain can further improve performance without increasing complexity.

The algorithm described above may perform in a single step coarse- and fine-frequency synchronization in OFDM MIMO systems, and achieves increasing performance with increasing number of antennas. The algorithm has also been found to effect a performance advantage over conventional approaches even in the SIMO (single input multiple output) configuration.

Note that two possible sets of training symbols (that are periodic waveforms in the time domain) are defined herein. The first uses the algorithm presented above and is more highly complex in nature. In a simpler alternative, no frequency-domain weighting of the received signal is performed. In this case, the algorithm makes use of training symbols that are simply time orthogonal between different antennas. In this case the same subcarriers can be used in the training symbols for different antennas.

The training symbols will preferably be defined in directly in the time domain, as a mapping between a low peak to average power ratio (PAPR) set of symbols, such as QPSK, and M different pseudo noise (PN) sequences. The definition of a signal with time period N/ξ will ensure that the subcarriers used are the same as considered in definition (3), above. Finally, the frequency offset estimation will be carried out based on the equations (9), (10), and (11), above.

Note also that the final specification of the training symbols in either case also depends on the design of the whole system as a whole. The training symbols may be built up by first dividing the whole frequency domain in M sets, then selecting the active subcarriers, the other subcarriers being put to zero. A PN sequence with null or nearly null DC value is attributed to the active subcarriers. After IFFT and computation of the PAPR, the process is preferably repeated to find sequences that present a reasonably low PAPR. A reasonable target is the definition of a training sequence that has a PAPR lower than the average PAPR in the payload. In one exemplary definition, N=2048 and ξ=16.

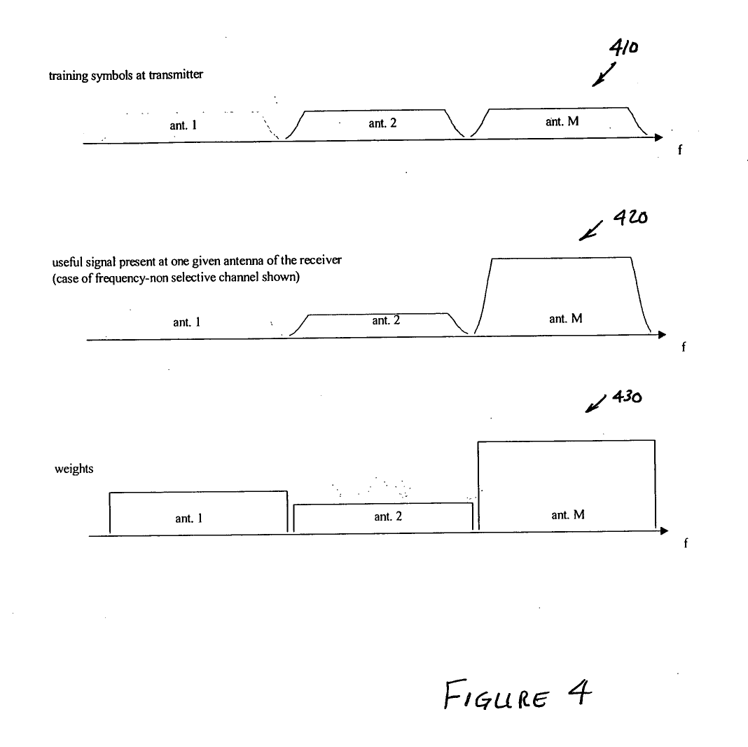

FIG. 4 presents a series of frequency-domain plots illustrating the use of weighting in the frequency domain. This Figure presents a simple case in which training symbols are completely separate in the frequency domain. Active subcarriers are one every ? subcarriers. Plot 410 illustrates the training symbols at the transmitter, corresponding to antenna 1, antenna 2, and antenna M, respectively. Plot 410 illustrates a useful signal present at one given antenna of the receiver for the case of a frequency non-selective channel. Plot 430 represents the weights determined accordingly. Note again that this is a simple case; in practice the various training symbols can occupy subcarriers according to different patterns.

The preferred descriptions above are of preferred examples for implementing the invention, and the scope of the invention should not necessarily be limited by this description. Rather, the scope of the present invention is defined by the following claims.

1. A method for synchronizing in the receiver of an orthogonal frequency division multiplexing (OFDM) wireless communication system where the OFDM transmitter inserts training symbols in transmission signals, said method comprising the steps of:
receiving a OFDM transmission;
developing a weighted representation of the received signal
performing frequency synchronization of the received signal using the developed weights.

2. The method of claim 1, further comprising the step of performing a course-time synchronization of the received signal prior to the step of developing a weighted representation.

3. The method of claim 2, wherein the OFDM transmission is a packetized data transmission and wherein the course-time synchronization comprises packet detection.

4. The method of claim 2, further comprising the step of performing a fine-time synchronization of the received signal prior to the step of developing a weighted representation.

5. The method of claim 2, further comprising the step of performing a fine-time synchronization of the received signal subsequent to the step of performing frequency synchronization.

6. The method of claim 1, wherein the wireless communication system is a multiple-input multiple output (MIMO) OFDM system, and wherein the step of performing frequency synchronization of the received signal is performed for the signal received through at least one receive antenna.

7. The method of claim 6, wherein the step of performing frequency synchronization of the received signal is performed for the signals received through all of the receive antennas.

8. The method of claim 1, wherein the training symbols have been modulated in an OFDM modulator of the transmitter, and wherein the performing frequency synchronization further comprises the step of performing fast Fourier transform (FFT) filtering.

9. The method of claim 8, wherein the performing frequency synchronization further comprises the step of recomposing the received signal using an inverse fast Fourier transform (IFFT) subsequent to FFT filtering.

10. An apparatus for the synchronization of wireless transmissions received from an OFDM transmitter, said apparatus comprising:
at least one antenna for receiving the OFDM transmission signal;
a frequency synchronization module couple to the at least one antenna for developing a weighted representation of the received signal;
a frequency offset compensation module for performing frequency offset compensation on the received signal using the weighted representation developed by the frequency synchronization module.

11. The apparatus of claim 10, wherein the at least one antenna comprises a plurality of antennas, and further comprising a plurality of frequency synchronization modules, each frequency synchronization module coupled to one of the plurality of antennas.

12. The apparatus of claim 10, wherein the OFDM transmission includes data in packet form and further comprising a packet detector coupled to the at least one antenna and to the frequency synchronization module.

13. The apparatus of claim 10, wherein the frequency synchronization module comprises a fine-time synchronization module for performing fine-time synchronization on the received signal prior to the developing of a weighted representation of the received signal.

14. The apparatus of claim 10, further comprising a fine-time synchronization module coupled to the frequency synchronization module for performing fine-time synchronization on the frequency synchronized module.

15. The apparatus of claim 10, wherein the a frequency synchronization module couple further comprises an FFT filter for applying an FFT to the received signal prior to developing the weighted representation.

16. The apparatus of claim 15, wherein the a frequency synchronization module couple further comprises an IFFT function for recomposing the transformed signal subsequent to developing the weighted representation.

17. The apparatus of claim 10, wherein the apparatus is included in terminal operable in a cellular telephone network.

18. The apparatus of claim 10, wherein the apparatus is included in terminal operable in a wireless local area network (WLAN).
